(19) United States
(12) Patent Application Publication
(10) Pub. No.: US 2021/0166168 A1
(43) Pub. Date: Jun. 3, 2021

(54) CUSTOMIZABLE DATA PROCESSING AND NOTIFICATION SYSTEM FOR EQUIPMENT SENSOR MONITORING AND ALERT NOTIFICATIONS

(71) Applicant: ALERT2GAIN CORP., Kansas City, KS (US)

(72) Inventors: Ivan Pedreros, Kansas City, KS (US); Connie McCabe, Kansas City, MO (US); Carlos Eduardo Alvarado Pedreros, Kansas City, MO (US)

(21) Appl. No.: 16/701,557

(22) Filed: Dec. 3, 2019

(51) Int. Cl. G06Q 10/06; G08B 21/18

(52) U.S. Cl. CPC G06Q 10/0635; G08B 21/18

(57) ABSTRACT

A system for receiving and processing data in real time on the cloud to trigger notifications and work procedures. The data received is based on pattern matching and anomaly detection streamed by sensors distributed in different networks and/or geographic locations. This system allows users to simplify the analysis, identification of and response to patterns in data that may indicate the near occurrence of an event that could negatively affect the user's assets, machinery, equipment and/or people. With this system, such damaging incidents may be prevented or minimized by taking early action via immediate communication mechanisms with key users and execution of tasks by autonomous equipment and personnel in the field.

### BACKGROUND OF THE INVENTION

### 1. Field of the Invention

The present invention relates generally to a data processing and notification system and method for use thereof, and more specifically to a customizable intelligent system for receiving and processing sensor data on the cloud in real time in order to trigger alert notifications and work procedures with multiple execution paths based on the detection of user-specified patterns or machine-learning anomaly detection algorithms run over the streaming data.

### 2. Description of the Related Art

Billions of dollars have been spent on technology to monitor and control assets in the field, yet conditions remain that are not mitigated in time or properly addressed to the personnel who would be best suited for fast and accurate responses. Multiple solutions provided by multiple parties which do not integrate or interact well with one another produces too much technology to manage and can often lead to conflicting or even incorrect data being reported. What is needed is a system which can integrate with existing hardware and software systems onboard equipment or within computer networks to quickly and accurately diagnose issues and provide alert notifications to the proper personnel or departments.

Heretofore there has not been available a system or method for a data processing and notification system with the advantages and features of the present invention.

### BRIEF SUMMARY OF THE INVENTION

The present invention generally provides a system for receiving and processing data in real time on the cloud to trigger notifications and work procedures. The data received is based on pattern matching and anomaly detection streamed by sensors distributed in different networks and/or geographic locations. This system allows users to simplify the analysis, identification of and response to patterns in data that may indicate the near occurrence of an event that could negatively affect the user's assets, machinery, equipment and/or people. With this system, such damaging incidents may be prevented or minimized by taking early action via immediate communication mechanisms with key users and execution of tasks by autonomous equipment and personnel in the field.

### BRIEF DESCRIPTION OF THE DRAWINGS

The drawings constitute a part of this specification and include exemplary embodiments of the present invention illustrating various objects and features thereof.

FIG. 1 is a diagrammatic representation of elements of a preferred embodiment of the present invention.

FIG. 2 is a diagrammatic representation of several assets embodying elements of the embodiment thereof.

FIG. 3 is a diagrammatic representation of data flow through the embodiment thereof.

FIG. 4 is a flow chart diagramming the steps taken during a data reception process of the embodiment of the present invention.

FIG. 5 is a flow chart diagramming the steps taken during a data normalization and correlation process of the embodiment of the present invention.

FIG. 6 is a flow chart diagramming the steps taken during a pattern matching, classification, and anomaly detection process of the embodiment of the present invention.

FIG. 7 is a flow chart diagramming the steps taken during a notification process of the embodiment of the present invention.

FIG. 8 is a flow chart diagramming the steps taken during a notification communication process of the embodiment of the present invention.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Data Processing and Notification System 2

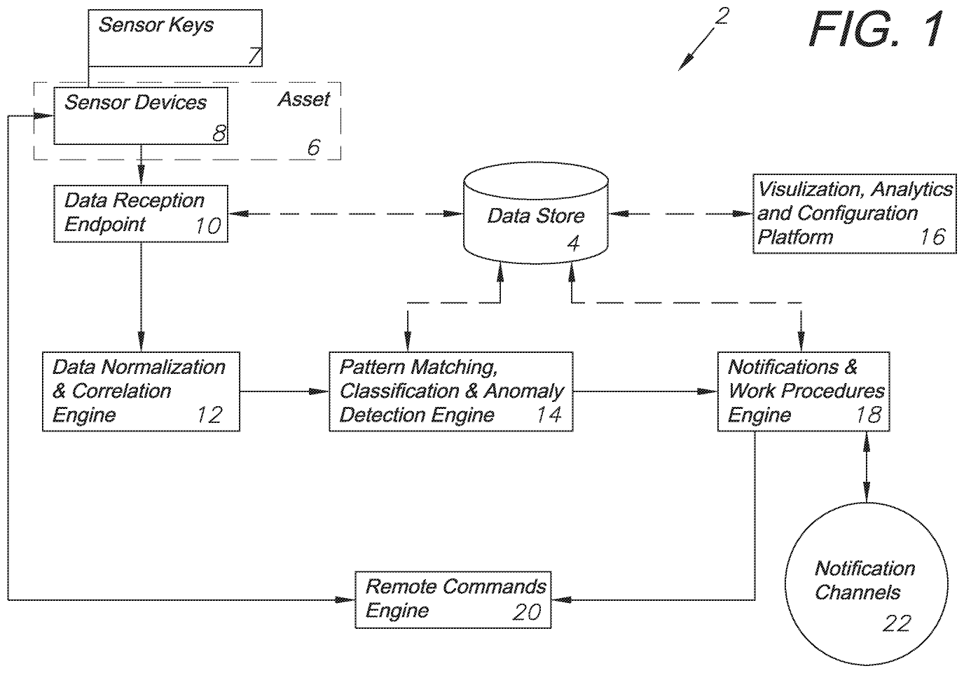

As shown in FIG. 1, the data processing and notification system 2 is comprised by one or more sensor devices 8 which transform an electrical, chemical, physical or digital stimulus in an output signal. Said sensor(s) are generally mounted to equipment 6 or other valuable assets for constant monitoring of those assets. Said sensor(s) 8, comprised of hardware and/or software elements, transmits this output through a communications channel to a Data Reception Endpoint 10, typically comprising a computer processing unit (CPU). This Data Reception Endpoint 10 validates the authenticity of the received data packets by reading a pair of digital alphanumeric keys that must be sent by the sensor(s) 8: one key allows the sensor to establish a connection and other identifies the sensor as a unique logic unit (the sensor keys 7). Data that complies with the security specifications is sent to a data store 4, which is composed of one or more file and database servers which may implement encryption algorithms to secure the stored data. These servers can be configured to operate as a cluster, act as a mirror or operate independent of one other. Additionally, the received data is sent to a Data Normalization and Correlation Engine 12, generally comprising another CPU, which transforms the data according to user-provided configurations and then correlates it in order to obtain new data by using mathematical formulas, models and algorithms. The resulting data structures are then forwarded to a Pattern Matching, Classification & Anomaly Detection Engine 14, comprising the same or another CPU, which evaluates the data structures by applying pattern-matching logic and mathematical models that classify and/or detect deviations on the source data based on past data received from the same sensor logic unit.

Mathematical formulae which may be implemented in interpreting sensor 8 data from assets 6 would include arithmetic operations over one or more data fields; threshold validation such as determining field values over, under, or between certain predetermined value levels; power, square root, or other linear or polynomial calculations on one or more data fields; count or aggregation of data fields, such as reading and reporting the number of data packages that comply with one or more logic rules; or other mathematical formulas as specified by users or personnel which may be asset-dependent for maximizing performance while minimizing risk to the assets.

Models which may be implemented in determining asset 6 operation based upon received sensor 8 data would include linear or polynomial interpolation models; statistical models based on past data related to the specific asset(s) 6; environmental models, which may include predictive weather or other environmental factors as detailed more below; and other models designed for specific industry and/or case-specific analysis as needed.

Algorithms which may be used in conjunction with the formulae and models above would include algorithms composed of one or more mathematical formulas and/or models as indicated above; alphanumeric and regular expression processing algorithms; geographical and spatial matching and analysis algorithms; and other algorithms designed for specific industry and/or case-specific analysis as needed.

Pattern matching logic and mathematical models could include the same mathematical, models, and algorithms as indicated above, as well as neural networks for anomaly detection; neural networks for sentiment analysis in alphanumeric information; neural networks for text classification in alphanumeric information; neural networks for classification over one or more data fields; ensemble neural networks which weight their results to provide an output; and other machine learning models designed for specific industry and/or case-specific analysis as needed.

External sensor devices 8, such as environmental monitoring stations which monitor weather, CO2, water streams, or other environmental elements that may affect or relate to a job site, or any other of independent sensor that may be performing measurements and/or actions without being part of a physical asset 6 such as a truck, robot or other physical machinery, may also be necessary for receiving and determining necessary steps in practicing the present invention. For example, if weather monitoring stations indicate impactful weather forecasts that may make it difficult for a specific asset 6 to perform its function without taking additional steps, messaging to the appropriate personnel may be necessary. Alternatively, the system could automatically direct these assets 6 to automatically perform steps which will protect their functions, such as limiting speed, increasing heating peripherals, or other important optional functions.

When this Pattern Matching, Classification & Anomaly Detection Engine 14 detects a pattern, specific class/group of classes or an anomaly, it sends a signal to the Notifications & Work Procedures Engine 18, again comprising the same or a different CPU, which starts a notification graph comprised of nodes that represent actions generally described as Notification Channels 22, such as sending an instant message through different communications channels to one or more users or calling one or more users via phone to give a prerecorded message or one generated by a computer-based user configuration and contextual data provided by the Notifications & Work Procedures Engine 18.

This mechanism can also communicate with an external application through an internet protocol and send parameters based on user configurations or contextual information provided by the Notifications & Work Procedures Engine 18, and/or enqueue a command to a Remote Commands Engine 20 with additional parameters provided by the Notifications & Work Procedures Engine 18. These commands are transmitted to one or more Sensor Devices 8 and once received are used by said sensors 8 to execute specific tasks such as (but not limited to) activating/deactivating peripheral devices, adjusting equipment operational values, updating information on one or more screens, playing a sound or voice recording, triggering the movement of mechanisms that control one or more processes.

In addition, the system comprises a Visualization, Analytics and Configuration Platform 16 that is protected by authentication. With this, authorized users can visualize the data transmitted by the sensors, and configure the operation of the a Data Normalization and Correlation Engine 12, the Pattern Matching, Classification & Anomaly Detection Engine 14 and the Notifications & Work Procedures Engine 18, which allows a user to customize how the system must treat the received data, evaluate patterns, classify and detect anomalies, and behave when one of the predecessors is identified: who is notified, via which channels and which commands must be sent to sensor devices while running the notifications flow. If automated, this system can automatically send commands to the sensor(s) 8 which can transmit control or operations commands to asset systems, such as turning off or on peripherals, redirecting the asset, or halting the asset completely pending repairs.

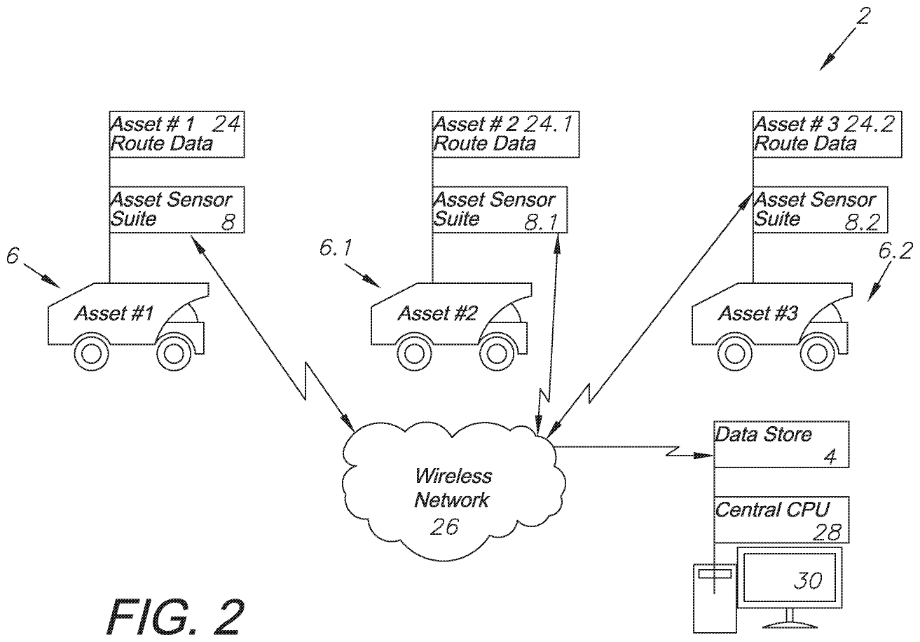

FIG. 2 shows this in a simplified manner how one or more assets 6, 6.1, 6.2 can transmit route data 24, 24.1, 24.2, or other relevant data (e.g. position data, operation time data, or other routine operational asset data) as well as sensor data from their internal sensors 8, 8.1, 8.2, respectively, through a network, such as a wireless cloud-based network 26, to the data store 4, which includes one or more central CPUs 28 and may include a graphical user interface (GUI) 30 for receiving and interpreting messages sent by the assets. The process as shown in FIG. 1 and as described above proceeds as the various sensor and asset data is received, utilizing the Data Normalization & Correlation Engine 12, the Pattern Matching, Classification & Anomaly Detection Engine 14, the Notifications & Work Procedures Engine 18, and, if determined necessary by those engines, the Remote Commands Engine 20 which then sends command back to the asset in question.

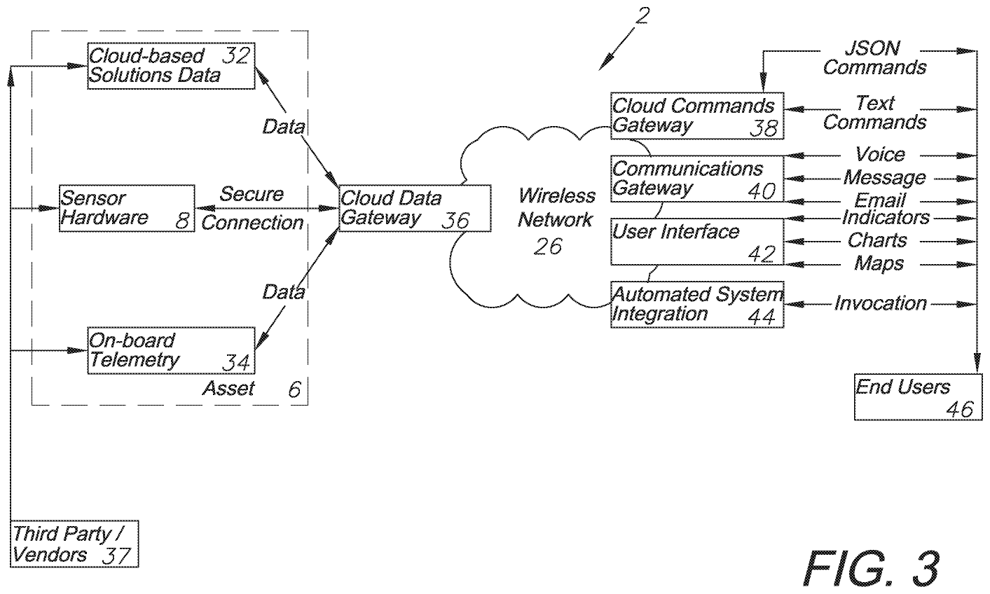

FIG. 3 diagrams how the present data processing and notification system 2 integrates existing cloud-based solutions data 32, asset sensors 8, and on-board telemetry 34 (including the route data 24), generally provided by and monitored using third parties/vendors 37, and turns them into useful notifications and feedback which can be quickly used to analyze and fix issues. Data is sent through existing data pathways and secure connections through a cloud data gateway 36 into the network 26 of the present data processing and notification system 2. This proprietary cloud-based network includes a cloud commands gateway 38, communications gateway 40, at least one user interface 42, and automated system integration 44, which directs data and commands appropriate locations, sub-systems, and personnel.

Examples of data circulated through the cloud-based network is shown further in FIG. 3. The Cloud Commands Gateway 38 communicates Java Script Object Notification (JSON) Commands, Text Commands, and other control commands between end users 46 and the asset(s) 6 via the cloud network 26. Similarly, the Communications Gateway 40 controls the transfer of voice, text messaging, email messaging, and other typical messaging systems for communication between personnel, end users, and the asset(s) for communicating reported issues and feedback. The User Interface 42 can provide indicators, charts, maps, and other related data to the end users 46 and facilitate the proper responses and feedback. The Automated System Integration 44 uses invocation between the end users 46, the asset(s) 6, and other connected elements for any automated responses to the various system stimuli.

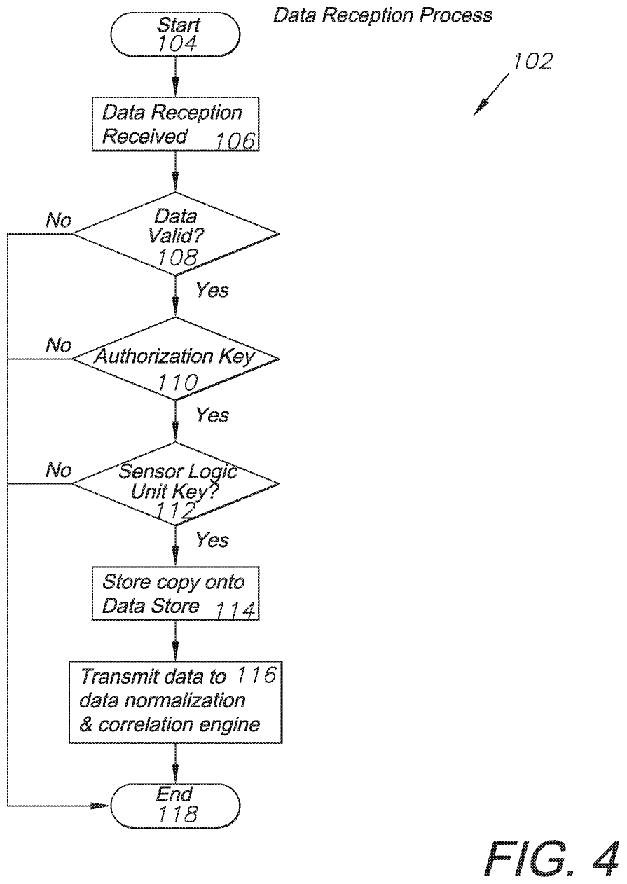

FIGS. 4-7 show various flowcharts diagramming steps of the present invention. The system operates with the following steps: (1) Reception of data generated by sensor devices that collect data from signals, readings, indicators, and human input. (2) Storage of said data in the system data store. (3) Normalization of the received data by one or more algorithms, zero or more correlations with other data or notifications stored within the system digital storage if specified in the system configuration. (4) Processing by at least one pattern-matching rule, classifier, or anomaly-detection model by an engine that activates the notification and work procedures engine. (5) In notifications and procedures engine, real-time execution of nodes comprised of communications channels that notify a list of users defined within the system digital storage and communicate with external systems (software, computer programs, hardware devices, screens, dashboards and any other connected system). (6) Command engines communicate with sensor devices. (7) Users can connect to a user platform that provides user interfaces to interact with the system's data. The user interfaces are comprised of notification management, correlation management, pattern management, data sources management, system indicators, user management and communication engine management.

FIG. 4 is a flow chart stepping through a data reception process 102. The process starts at 104 reception of data generated by the sensor(s) device(s) 8 that collect data from signals, readings, indicators, and human input occurs at 106. The system determines if the data from the sensors is valid at 108. A check to determine if the data contains an authorization key (one of the sensor keys 7) occurs at 110. A further check to determine if the data includes a sensor logic unit key (one of the sensor keys 7) at 112. If all of these tests are passed, storage of the sensor data in the system data store occurs at 114 and data is transmitted to the data normalization and correlation engine 12 at 116 and the process ends at 118. If any of the tests at steps 108, 110, or 112 fail, the process immediately ends and the data is ignored.

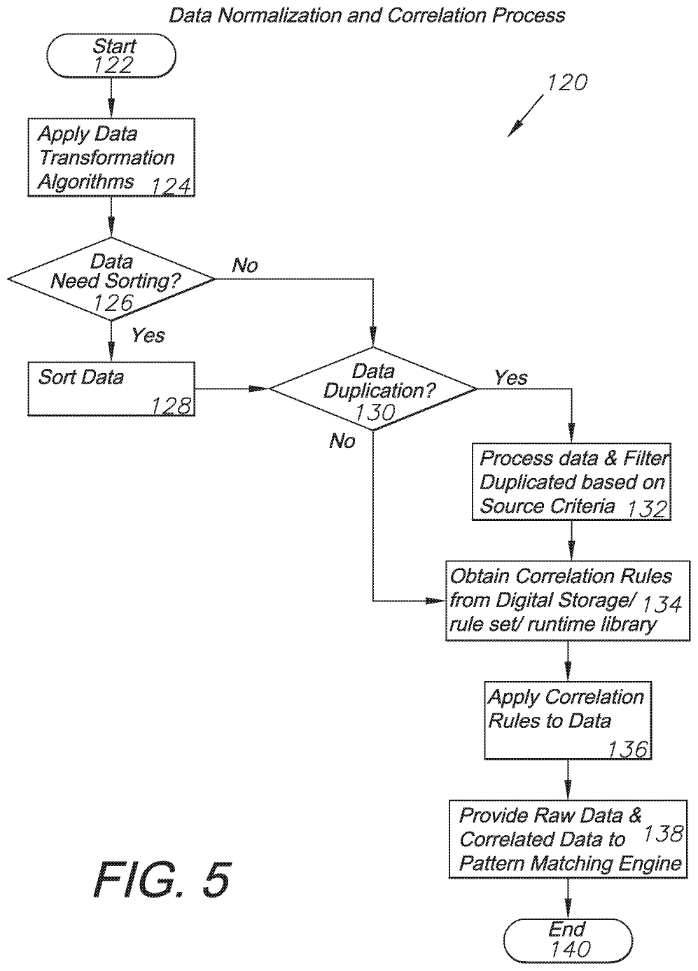

FIG. 5 illustrates the data normalization and correlation process 120 performed by the data normalization and correlation engine 12 and starts at 122. Data and transformation algorithms are applied at 124 in order to prepare the pattern matching, classification, and anomaly-detection engine 14. A check occurs at 126 to determine if the data requires sorting. If the data needs sorting, it is sorted at 128, otherwise a check is determined whether data duplication has occurred at 130. If data could have been duplicated, the data is processed and filtered to remove duplicated data based upon predefined source criteria at 132. Next, data correlation rules are obtained from the data store 4 or other sources at 134 and are applied to the data at 136. The raw date and correlated data is then sent to the Pattern Matching, Classification & Anomaly Detection Engine 14 at 138. The data normalization and correlation process 120 then ends at 140.

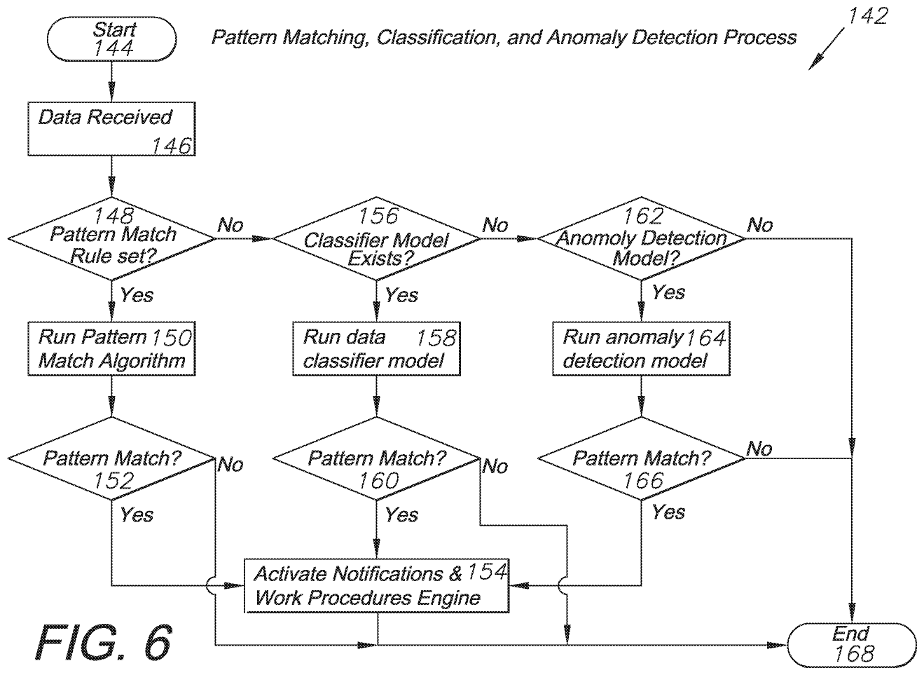

FIG. 6 illustrates steps taken during the pattern matching, classification, and anomaly detection process 142 carried out by the Pattern matching, Classification & Anomaly Detection Engine 14, the process beginning at 144. Data is received from the Data Normalization and Correlation Engine 12 at 146. First, a check is performed to determine if there are set pattern-match rules to the received data at 148. If not, the system then checks whether there exist any classifiers to the received data at 156. If not, the system finally checks whether there are any anomaly detection models to the data at 162. If there are none, the process ends at 168 and the data is discarded.

However, if a pattern match rule set exists to the data at 148, the pattern match algorithm is run at 150. If a pattern match is detected at 152, the Notifications & Work Procedures Engine 16 is activated at 154, otherwise the process ends at 168. Similarly, if a classifier model exists for the data at 156, the appropriate data classifier model is run at 158 and a pattern match is determined at 160. If there is a pattern match, the Notifications & Work Procedures Engine 16 is activated at 154, otherwise the process ends at 168. Finally, if the anomaly detection model exists at 162, the appropriate anomaly detection model is run at 164. A pattern match is queried at 166, and if there is a pattern match, the Notifications & Work Procedures Engine 18 is activated at 154, otherwise the process ends at 168.

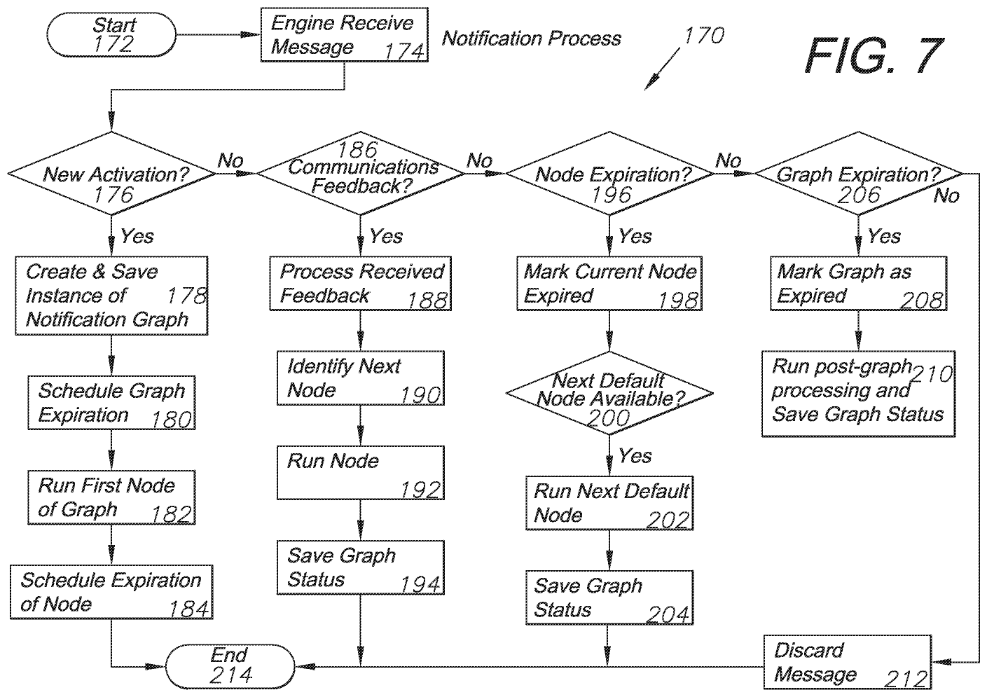

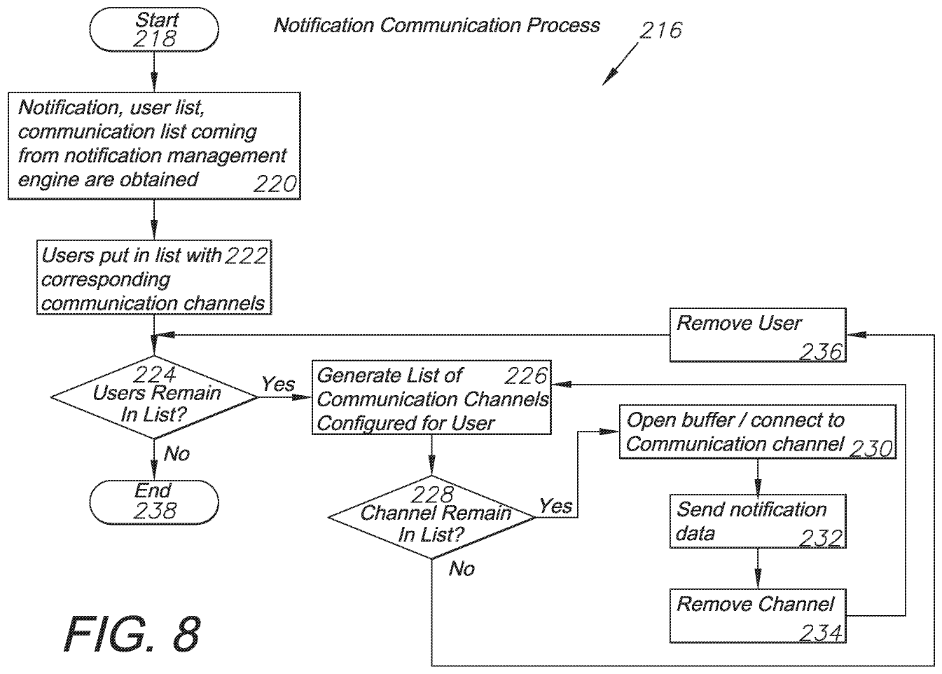

FIG. 7 shows the steps taken during a final stage of the present data processing and notification system 2, which includes the notification process 170 which begins at 172. This process runs parallel asynchronously to the process diagrammed in FIG. 8. First, the Notifications & Work Procedures Engine 18 receives the message from the Pattern Matching, Classification, and Anomaly Detection Engine 14 and its associated process 142 of FIG. 6 at 174. This message may contain instructions for activation of a new notification graph at 176, a response provided by a communications channel that was used by a current active node at 186, a message that notifies the expiration of a current node at 196, or a message that notifies the expiration of a graph at 206.

If the message contains instructions for activation of a new notification graph at 176 by the Pattern Matching and Anomaly Detection Engine 14 at 176, then a save instance of the new notification graph is created at 178. A new notification graph composed of nodes that execute specific actions, which may include sending a message through instant communication, executing a phone call, communicating with an external application, or enqueuing a new command to a sensor device. Next, an asynchronous message to trigger the expiration of the newly created graph if no positive feedback is received during its lifetime is scheduled at 180. The first node of the graph and its configured actions are run at 182, and an asynchronous message that will expire the current node if no positive feedback is received during its execution over a preconfigured period of time occurs at 184. The process then ends at 214.

If the message contains a response by a communications channel that was used by a current active node at 186 (“communications feedback”) instead, the received message is processed and actions are executed related to the received feedback at 188. Based on that feedback, the next execution node is identified at 190, is executed and its expiration is scheduled based on a user-configured period of time at 192, and the graph status is updated on the data store 4 at 194. The process then ends at 214.

If the message notifies the expiration of a current node at 196 instead, the graph is updated and the current node status is set to expired, disabling all possible executions and feedback that node could trigger at 198. A next default node is selected at 200. A default node is the one that is triggered in the event the current active node does not receive a positive feedback and, if it's found, the newly found node is executed and an expiration message of itself is scheduled based on a user-set period of time at 202 and the graph status is updated on the data store 4 at 204 and saved, or if no default node is identified, the graph status is updated. The process then ends at 214.

Finally, if the message that notifies the expiration of a graph at 206, the graph status is marked as expired, disabling all possible actions and node executions at 208. After that, post-processing tasks are executed and the final status of the graph is updated on the data store 4 at 210. The process then ends at 214.

Otherwise, if the message is unidentified, the process discards the message at 212 and the process ends at 214.

FIG. 8 diagrams the steps of a notification communication process 216 which begins at 218. The communication engine receives from the notification management engine a notification, which includes its user list and communication channel list at 220. The users are put into a list with their correspondence communications channels at 222. A check determines whether users remain on the list at 224, and if there are users on the list remaining the communication engine executes the indicated steps for every user. First, the communications channels configured for a user are put into a list at 226. A check determines if that user remains associated with any channels at 228. If there are channels remaining, a connection is open to the communications channel at 230, the notification data is sent through the connections at 232, and the communications channel is then removed from the list at 234. This process continues until all communications channels are removed for the selected user. Once determined that no channels remain, the user is removed from the list at 236. This process continues at 224 until all users are sent notifications, then the communications process ends at 238. This ensures that all appropriate users are contacted through all predetermined appropriate channels for the best results.

By stepping through these processes and either automating actions after communications are received by the asset sensors or ensuring notifications are sent to the appropriate users, all possible fail-safes are ensured and best-case results are guaranteed that will prevent or mitigate damage or errors resulting from the activation or utilization of the assets.

The present invention can contribute to timely, more informed, automated management in Agribusiness, Mining, Manufacturing, Energy, Financials and Trading. Examples below indicate how embodiments of the present invention may be used in specific applications, however these are merely illustrations of the present invention at work, and the present invention is extremely customizable.

A first example includes a use in the agriculture industry. A client, such as a farm that has already deployed sensors 8 for collecting data (e.g. soil temperature and humidity at varying depths, crop size, UV radiation, pesticide levels in different zones of the property), and/or has access to weather monitoring station that measure wind speed, rain, humidity, atmospheric pressure, or other factors. The sensors 8 stream their measurements to the system's 2 data endpoint 10 where intelligence correlates the information and automatically produces responses or action plans customized per zone through a process such as that indicated in FIG. 2. For example, when the system 2 detects a critical irrigation requirement with pattern matching—one zone requires water while a second zone does not need additional water—the system 2 activates an alert flow. This flow sends commands to irrigation devices (assets 6) to manage both issues and simultaneously notifies land workers and managers (end users 46) that irrigation adjustments were executed. The invention has been configured to generate an additional level of notifications to land workers and managers if conditions do not improve after the automatic response is completed. In this case, a work procedure with recommended steps for further actions is attached to the message to the end user 46 personnel.

Another example includes a mining operation. In recent years, mining companies have invested heavily in complementary devices/sensors to better monitor their operations. Unfortunately, because many such solutions are stand-alone systems and data analysis often occurs long after the fact, most companies have not been seeing big returns on their tech investments. The present system 2 automatically integrates these existing systems, applies intelligence to data through a determined algorithm and alerts operations managers of critical or dangerous situations in real time. In a preferred embodiment a mining operation sets up the present invention as a way to improve overall safety. The mine operation deploys different sensors 8 to monitor mine stability, and these sensors stream to the system's data endpoint 10 data about a displacement occurring on the mine walls in real time. When the displacement exceeds a certain amount over time as determined through a mathematical formula, the system 2 triggers a specific alert flow to a zone supervisor (end user 46). The supervisor has one minute to confirm course of action: to continue working or to cease operations. If the supervisor does not confirm within a minute, the escalation engine automatically moves the alert to the next decision-maker/makers with another action-confirmation request. If no answer is received after 5 minutes, warning sirens are activated in the work zone to indicate to workers that they need to evacuate because abnormal conditions were detected. With the present invention, alerts are immediate so that decisions can be immediate, thus potentially saving lives and preventing accidents.

A third example includes a manufacturing process. Anything that unnecessarily stops production in manufacturing is costly. To prevent such gratuitous losses, the present invention can be designed to intervene without halting production. To start, a manufacturing facility equipped with sensors 8 (such as conveyor status, idler temperature/speed, idler sound/alignment, robot-arm orientation/vibrations, etc) connects its systems and robot arms to the present system 2 so that vital signs can be transmitted through the process as described above. The system's 2 pattern matching and anomaly detection engine 14 analyze this streaming data, and if a pattern or anomaly is detected, the invention activates an alert flow that sends correction signals to the equipment (asset 6) in order to update operational parameters without disrupting operations. At the same time, the system 2 sends a dispatch order through the communications gateway 40 to the machinery operators with a report on findings and a request, if necessary, for further review of conditions and additional actions needed to correct the issue(s).

A fourth example includes the energy industry. An example industrial operation deploys sound, vibration and heat sensors 8 for its substation transformers (assets 6). Those sensors are connected by a wireless network 26 to the system 2, and they transmit reports on said measurements as often as it is deemed necessary or predetermined. The invention's anomaly detection neural network (e.g. the data normalization & correlation engine 12, pattern matching, classification & anomaly detection engine 14, and notification s& work procedures engine 18) correlates the signals for every transformed connection and scores the status. With that, abnormalities can be detected based on historical data and/or data from third party vendors 36 as relevant. When an anomaly is detected, an immediate notification is activated so that maintenance workers (end users 46) have the latest readings of transformer status and comparable data, as well as a work-procedure checklist to follow up on transformer status and, if needed, take further actions.

A fifth example includes the financial industry. A software system for monetary transactions requires authentication and face recognition to confirm a potential money transfer. The system 2 analyzes every transaction locally (on the same CPU or by a supplementary system) and when a potential fraud occurs, this system 2 streams the account number, location, device identification tag and other information to the invention data endpoint. Here, the present invention triggers an alert flow and notifies the account owner and account executive of the potential fraud by phone while sending an email to the account owner with a complete report and a photo of the person who tried to perform the transaction.

Finally, and similarly, the trading industry also includes examples of uses of the present invention. A forex trading station extracts real-time data from different currency pairs and streams the data to the invention data endpoint. The present invention's system 2 applies correlation with mathematical and statistical formulas including polynomial and linear interpolation and employs pattern matching to divulge potential transaction opportunities. When a transaction opportunity is detected, an opportunity index is established and sent to the owner of the trading account and/or account manager. The message requests a confirmation of the transaction in the form of immediate action: to either execute the trade or decline. If the opportunity index reaches a certain threshold and the user doesn't respond within a preset period of time, the alert flow system can be designed to send a command to the trading station to automatically execute the transaction and notify the user of this action.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A data processing and notification system comprising:
an asset comprising a sensor, said sensor comprising at least one sensor key, said at least one sensor key configured to electronically identify and communication an identity of said sensor;
a computer database comprising a graphical user interface (GUI), computer processing unit (CPU), and data storage;
a communications network connecting said asset with said computer database;
a data normalization and correlation engine operable by said CPU;
a pattern matching, classification, and anomaly detection engine operable by said CPU;
a notifications and work procedures engine operable by said CPU;
a plurality of notification channels stored within said data storage and accessible by said CPU, said plurality of notification channels associated with a plurality of users;
said sensor configured to generate a notification, said notification configured to be analyzed through said data normalization and correlation engine, said pattern matching, classification, and anomaly detection engine, and said notifications and work procedures engine by said CPU, thereby generating a determination; and
said determination configured to trigger an action, said action communicated to said asset and said action performed by said asset.

2. The data processing and notification system of claim 1, further comprising:
said asset comprising a plurality of peripheral devices; and
said action configured to control at least one of said plurality of said peripheral devices.

3. A method of detecting errors in a network of assets, reporting, and correcting the errors, the method comprising the steps:
monitoring an asset with a sensor, said asset in wireless communication with a wireless network;
sending reporting data through said wireless network from said sensor to a data endpoint on a predetermined schedule, said data endpoint communicatively connected with a remote server comprising a data storage unit, central processing unit (CPU), and network connection, and said reporting data comprising a sensor key;
assessing and validating said reporting data with said remote server;
confirming said sensor key with said remote server;
reviewing said reporting data with a data normalization and correlation engine;
preparing said reporting data for a pattern matching, classification, and anomaly-detection engine with said data normalization and correlation engine by transforming said reporting data into raw data;
checking for and removing duplicated data of said raw data with said data normalization and correlation engine;
correlating said normalized data according to correlation rules stored within said data storage unit, thereby generating correlated data;
sending said raw data and said correlated data to said pattern matching, classification, and anomaly-detection engine;
checking for and applying pattern-match rules to the raw data and the correlated data with said pattern matching, classification, and anomaly-detection engine;
checking for and applying classifiers to the raw data and the correlated data said pattern matching, classification, and anomaly-detection engine;
checking for and applying anomaly detection models to the raw data and the correlated data said pattern matching, classification, and anomaly-detection engine;
generating and sending a notice message to a notifications and work procedures engine with the pattern matching, classification, and anomaly-detection engine, said message containing response protocols to said raw data and said correlated data as analyzed via the pattern matching, classification, and anomaly-detection engine;
generating and sending an instructional message to personnel, said instructional message comprising instructional response commands regarding based upon raw data and said correlated data as analyzed via the pattern matching, classification, and anomaly-detection engine;
automatically adjusting performance protocols of said asset based upon said notice message; and
wherein said data normalization and correlation engine, said pattern matching, classification, and anomaly-detection engine, and said notifications and work procedures engine are procedural computerized processes run by said central server CPU.

4. The method of claim 3, further comprising the step of sorting said raw data.

5. The method of claim 3, further comprising the step:
activating said notifications and work procedures engine upon detection of a pattern-match with said pattern-match rules within said pattern matching, classification, and anomaly-detection engine.

6. The method of claim 3, further comprising the steps:
running a data classifier model upon detection of classifiers within said pattern matching, classification, and anomaly-detection engine;
recognizing a pattern match exists with said pattern matching, classification, and anomaly-detection engine; and
activating said notifications and work procedures engine upon detection of a pattern-match with said pattern-match rules within said pattern matching, classification, and anomaly-detection engine.

7. The method of claim 3, further comprising the steps:
running an anomaly detection model upon detection of an anomaly within said pattern matching, classification, and anomaly-detection engine;
recognizing a pattern match exists with said pattern matching, classification, and anomaly-detection engine; and
activating said notifications and work procedures engine upon detection of a pattern-match with said pattern-match rules within said pattern matching, classification, and anomaly-detection engine.

8. The method of claim 3, wherein said sensor key comprises a digital alphanumeric key configured to establish a connection with said wireless network.

9. The method of claim 3, wherein said sensor key comprises a digital alphanumeric key configured to identify said sensor as a unique logic unit.

10. A method of monitoring a machine asset, the method comprising the steps:
performing a physical function with the machine asset;
monitoring said physical function of the machine asset with a sensor, said sensor in wireless communication with a wireless network;
sending reporting data through said wireless network from said sensor to a data endpoint on a predetermined schedule, said data endpoint communicatively connected with a remote server comprising a data storage unit, central processing unit (CPU), and network connection, and said reporting data comprising a sensor key;
said reporting data comprising data related to said physical function of said machine asset;
assessing and validating said reporting data with said remote server;
confirming said sensor key with said remote server;
reviewing said reporting data with a data normalization and correlation engine;
preparing said reporting data for a pattern matching, classification, and anomaly-detection engine with said data normalization and correlation engine by transforming said reporting data into raw data;
checking for and removing duplicated data of said raw data with said data normalization and correlation engine;
correlating said normalized data according to correlation rules stored within said data storage unit, thereby generating correlated data;
sending said raw data and said correlated data to said pattern matching, classification, and anomaly-detection engine;
checking for and applying pattern-match rules to the raw data and the correlated data with said pattern matching, classification, and anomaly-detection engine;
checking for and applying classifiers to the raw data and the correlated data said pattern matching, classification, and anomaly-detection engine;
checking for and applying anomaly detection models to the raw data and the correlated data said pattern matching, classification, and anomaly-detection engine;
generating and sending a notice message to a notifications and work procedures engine with the pattern matching, classification, and anomaly-detection engine, said message containing response protocols to said raw data and said correlated data as analyzed via the pattern matching, classification, and anomaly-detection engine;
generating and sending an instructional message to personnel, said instructional message comprising instructional response commands regarding based upon raw data and said correlated data as analyzed via the pattern matching, classification, and anomaly-detection engine;
automatically adjusting performance protocols of said asset based upon said notice message; and
wherein said data normalization and correlation engine, said pattern matching, classification, and anomaly-detection engine, and said notifications and work procedures engine are procedural computerized processes run by said central server CPU.

11. The method of claim 10, wherein:
said machine asset comprises a vehicle; and
said physical function comprises movement of an element of said vehicle.

12. The method of claim 10, wherein:
said machine asset comprises a machine having internal components; and
said physical function comprises activities undertaken by at least one of said internal components.

13. The method of claim 10, wherein:
said sensor comprises an external sensor configured to monitor environmental elements external to said machine asset; and
said physical function comprises functions of said machine asset affected by said environmental elements.
